(19) United States
(12) Patent Application Publication
(10) Pub. No.: US 2026/0349586 A1
(43) Pub. Date: Nov. 5, 2026

(54) METHOD, APPARATUS, DEVICE, AND MEDIUM FOR VIEW SWITCHING

(71) Applicant: Beijing Zitiao Network Technology Co., Ltd., Beijing (CN)

(72) Inventors: Ye Lei, Beijing (CN); Tianhao Zhang, Beijing (CN); Lan Ma, Beijing (CN); Wenbo Wang, Beijing (CN); Yan Zhang, Beijing (CN); Yuyan Cui, Beijing (CN)

(21) Appl. No.: 19/470,022

(22) PCT Filed: Oct. 30, 2024
(86) PCT No.: PCT/CN2024/128690

§ 371 Date: Sep. 26, 2025

(30) Foreign Application Priority Data
Nov. 2, 2023 (CN) 202311451824.6

(51) Int. Cl. G06F 3/0484

(52) U.S. Cl. CPC G06F 3/0484

(57) ABSTRACT

Provided are a method, an apparatus, a device, and a medium for view switching. In a method, a plurality of switch controls are presented in a display area of a client device, the plurality of switch controls respectively corresponding to a plurality of views to be presented in the display area; and a target view of the plurality of views that corresponds to a target switch control of the plurality of switch controls is presented in the display area in response to receiving a first user interaction for the target switch control. With the example embodiment in the disclosure, in the case where a plurality of views are included, view switching may be conveniently and quickly implemented via the switch controls, which facilitates improvement in the efficiency of view switching.

The application is a national stage application of International Patent Application No. PCT/CN2024/128690 filed on Oct. 30, 2024, which claims priority to Chinese Patent Application No. 202311451824.6, filed on Nov. 2, 2023, and entitled “Method, Apparatus, Device, and Medium for View Switching”, which is incorporated herein by reference in its entirety.

### FIELD

Example embodiments in the disclosure generally relate to the field of computers, and in particular, to a method, apparatus, device, and computer-readable storage medium for view switching.

### BACKGROUND

With the rapid development of computer technologies, computers have become one of the indispensable tools in people's daily lives. Users typically place application icons, such as software icons, or files, on a desktop of a computer, and launch software or open files via the desktop. Users may also present different contents in a display area via gestures, user interfaces, or the like. In this case, it is desired to switch between different contents in the display area in a more convenient and efficient manner.

### SUMMARY

In a first aspect in the disclosure, a method for view switching is provided. In the method, a plurality of switch controls are presented in a display area of a client device, the plurality of switch controls respectively corresponding to a plurality of views to be presented in the display area; and a target view of the plurality of views that corresponds to a target switch control of the plurality of switch controls is presented in the display area in response to receiving a first user interaction for the target switch control.

In a second aspect in the disclosure, an apparatus for view switching is provided. The apparatus includes: a control presenting module, configured to present a plurality of switch controls in a display area of a client device, the plurality of switch controls respectively corresponding to a plurality of views to be presented in the display area; and a view presenting module, configured to present a target view of the plurality of views that corresponds to a target switch control of the plurality of switch controls in the display area in response to receiving a first user interaction for the target switch control.

In a third aspect in the disclosure, an electronic device is provided. The electronic device includes: at least one processor; and at least one memory, the at least one memory coupled to the at least one processor and storing instructions executable by the at least one processor, the instructions, when executed by the at least one processor, causing the electronic device to perform the method of the first aspect.

In a fourth aspect in the disclosure, a computer-readable storage medium is provided. The computer-readable storage medium is with a computer program stored thereon, the computer program, when executed by a processor, causing the processor to implement the method of the first aspect.

It would be appreciated that content described in the summary in the disclosure is neither intended to identify key or essential features of the embodiments in the disclosure, nor to limit the scope of the disclosure. Other features in the disclosure will be readily envisaged through the following description.

### BRIEF DESCRIPTION OF THE DRAWINGS

The above and other features, advantages and aspects of the embodiments in the disclosure will become more apparent in the following, in conjunction with the drawings and with reference to the following detailed description. In the drawings, the same or similar reference symbols refer to the same or similar elements, where:

FIG. 1 illustrates a block diagram of an example environment in which the embodiments in the disclosure may be implemented;

FIG. 2 illustrates a block diagram of a display area in accordance with some embodiments in the disclosure;

FIG. 3 illustrates a block diagram of a desktop view in accordance with some embodiments in the disclosure;

FIG. 4 illustrates a block diagram of a launchpad view in accordance with some embodiments in the disclosure;

FIG. 5 illustrates a block diagram of a multitask view in accordance with some embodiments in the disclosure;

FIG. 6 illustrates a block diagram of a cross architecture in accordance with some embodiments in the disclosure;

FIG. 7 illustrates a flowchart of a process for view switching in accordance with some embodiments in the disclosure;

FIG. 8 illustrates a block diagram of an apparatus for view switching in accordance with some embodiments in the disclosure; and

FIG. 9 illustrates a block diagram of an electronic device in which one or more embodiments in the disclosure may be implemented.

### DETAILED DESCRIPTION OF EMBODIMENTS

The embodiments in the disclosure will be described in more detail below with reference to the drawings. Although some embodiments in the disclosure are shown in the drawings, it would be appreciated that the disclosure may be implemented in various forms and should not be construed as limited to the embodiments set forth herein. On the contrary, these embodiments are provided for a more thorough and complete understanding of the disclosure. It would be appreciated that the drawings and embodiments in the disclosure are only for illustrative purposes, and are not intended to limit the protection scope of the disclosure.

In the description of the embodiments in the disclosure, the term “include/comprise” and similar terms thereto should be understood as open-ended inclusions, that is, “include/comprise but not limited to”. The term “based on” should be understood as “at least partially based on”. The term “an embodiment” or “the embodiment” should be understood as “at least one embodiment”. The term “some embodiments” should be understood as “at least some embodiments”. The following may also include other explicit and implicit definitions. As used herein, the term “model” may represent an association between various data. For example, the above association may be acquired based on various technical solutions that are currently known and/or will be developed in the future.

It would be appreciated that the data involved in the technical solution (including but not limited to the data itself, acquisition or use of the data) should comply with requirements of corresponding laws, regulations, and related provisions.

It would be appreciated that before using the technical solution disclosed in the embodiments in the disclosure, the user should be informed of the type, range of use, use scenarios, etc., of personal information involved in the disclosure in an appropriate manner and the authorization of the user should be obtained according to relevant laws and regulations.

For example, in response to receiving an active request from a user, prompt information is sent to the user to clearly prompt the user that the requested operation will require access to and use of the user's personal information. As such, the user may independently choose, based on the prompt information, whether to provide the personal information to software or hardware, such as an electronic device, an application, a server, or a storage medium, that performs the operations of the technical solution in the disclosure.

As an optional but non-restrictive embodiment, in response to the receiving the active request from the user, the prompt information may be sent to the user in the form of, for example, a pop-up window, in which the prompt information may be presented in text. Furthermore, the pop-up window may also include a selection control for the user to select whether to “agree” or “disagree” to provide the personal information to the electronic device.

It would be appreciated that the above process of notifying and obtaining user authorization is only illustrative and does not constitute a limitation to the embodiments in the disclosure, and other manners that satisfy the relevant laws and regulations may also be applied in the embodiments in the disclosure,

The term “in response to” used herein represents a state in which a corresponding event occurs or a condition is satisfied. It would be appreciated that there is not necessarily a strong correlation between a time at which a subsequent action is performed in response to the event or condition and a time at which the event occurs or the condition is satisfied. For example, in some cases, the subsequent action may be executed immediately when the event occurs or the condition is satisfied; while in other cases, the subsequent action may be executed after a period of time has elapsed since the event occurred or the condition was satisfied.

### Example Environment

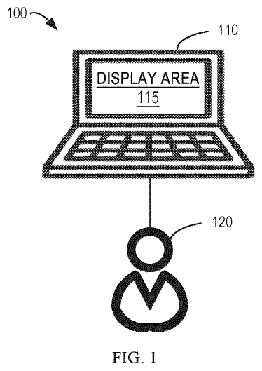

FIG. 1 illustrates a block diagram of an example environment 100 in which the embodiments in the disclosure may be implemented. In this example environment 100, a client device 110 may present different contents in a display area 115 of its own, and a user 120 may operate the client device 110 through the client device 110 or a peripheral device attached to the client device 110, so as to present a desired content in the display area 115.

In some embodiments, at least one application may also be installed on the client device 110. The user 120 may interact with the at least one application via the client device 110 and/or the peripheral device attached to the client device 110.

In some embodiments, the client device 110 may be any type of mobile terminal, fixed terminal, or portable terminal, including a mobile phone, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/video camera, a television receiver, a radio broadcast receiver, an e-book device, a gaming device, or any combination of the foregoing, including the accessories and peripherals of these devices, or any combination thereof. In some embodiments, the client device 120 may also support any type of user-directed interfaces (such as “wearable” circuitry and the like).

It would be appreciated that the structures and functions of various elements in the environment 100 are described for illustrative purposes only, without suggesting any limitation to the scope of the disclosure.

The client device 110 may present a view corresponding to a predetermined operation in the display area 115 in response to the predetermined operation by the user, for example, may present a corresponding view in response to a user gesture. However, the client device 110 is unable to present the architecture of the views during a view switching procedure, and is also unable to closely associate the gesture with the view architecture. Furthermore, the high complexity of gestures would affect user experience. At this point, how to conveniently and quickly switch views has become a difficult and hot issue in the field of computer technologies.

### Summary of View Switching

In order to at least partially address the deficiencies in the prior art, an example embodiment in the disclosure proposes a method for view switching. Some example embodiments in the disclosure will be described below with continued reference to the drawings. For ease of illustration, these example embodiments will be described in conjunction with FIG. 1. For case of use, different views may be presented in the display area. For example, a desktop view may include a predefined desktop, a launchpad view may include launch controls for installed applications, and a multitask view may include management controls for managing launched applications, and so on.

According to this solution, a plurality of switch controls respectively corresponding to a plurality of views are presented in the display area 115 of the client device 110. Furthermore, in response to receiving a user interaction for a target switch control of the plurality of switch controls, a target view corresponding to the target switch control is presented in the display area 115. In this way, in the case where a plurality of views are included, view switching may be conveniently and quickly implemented through the switch controls, which facilitates improvement in the efficiency of view switching. Furthermore, performing view switching based on the user interaction may strengthen an association between the user interaction and the view switching, and may improve the user experience during view switching.

### Detailed Process of View Switching

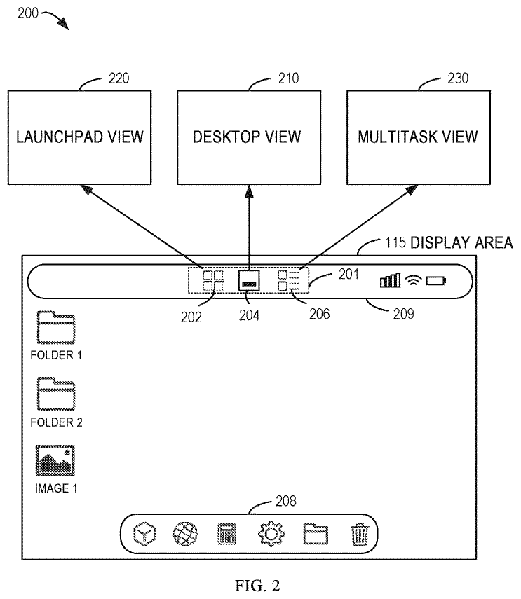

FIG. 2 illustrates a schematic diagram of the display area 115 in accordance with some embodiments in the disclosure. The client device 110 may present a plurality of switch controls (including a switch control 202, a switch control 204, and a switch control 206) in the display area 115, the plurality of switch controls respectively corresponding to a plurality of views to be presented in the display area 115. It would be appreciated that although only three switch controls are shown in FIG. 2, the disclosure does not limit the number of switch controls. Alternatively and/or additionally, more or fewer switch controls may be presented, and each switch control may correspond to a view.

In some embodiments, the client device 110 may directly present the plurality of switch controls at any position in the display area 115, and the plurality of switch controls may be located in the same area of the display area 115 in a centralized manner, or may be located in different areas of the display area 115 in a decentralized manner. For example, the client device 110 may present some of the plurality of switch controls in an upper area of the display area 115, and present other switch controls of the plurality of switch controls in a left area of the display area 115.

In order to ensure neatness of the display area 115, in some embodiments, the client device 110 may present the plurality of switch controls in a specific area (also referred to as a first area) of the display area 115. The first area here may be located at an edge of the display area (the edge here may be any edge of the display area, such as an upper edge, a lower edge, a left edge, and a right edge, which is not limited by the disclosure), and the first area is always presented during the operation of the client device and is not obscured by the window of an already launched application. As shown in FIG. 2, the client device 110 may always present an area 201 in which the plurality of switch controls are presented. In this way, it may be ensured that the plurality of switch controls are always presented in the display area 115, and the user may click on each switch control at any time to switch to a corresponding view.

In some embodiments, the display area 115 further includes a taskbar display area 208, and the client device 110 may present application identifications of the applications frequently used by the user in the taskbar display area 208. The applications frequently used here may be preset by the user, or may be automatically determined by the client device 110 based on the historical application usage by the user. In some embodiments, the client device 110 may also present the plurality of switch controls in the taskbar display area 208.

In some embodiments, the display area 115 further includes a status bar display area 209, which may be used to present a status of the client device 110, such as a current time, a network status, a battery status, and so on. In some embodiments, the client device 110 may also present the plurality of switch controls in the status bar display area.

Regarding a positional relationship of the plurality of switch controls, in some embodiments, the client device 110 may obtain a view architecture of the plurality of views, and present the plurality of switch controls based on a positional relationship between the plurality of views represented by the view architecture. The view architecture here may be preset by the user of the client device 110, or may be default to the client device 110.

For example, if three switch controls need to be presented, and a positional relationship of the views corresponding to the three switch controls in the view architecture is a horizontal left-center-right order, the three switch controls may be presented in the area 201 according to the positional relationship of the corresponding views and the horizontal left-center-right positional relationship. Specifically, a switch control for switching to a left view of the plurality of views is located on the left side of the area 201, a switch control for switching to a middle view of the plurality of views is located in the middle of the area 201, and a switch control for switching to a right view of the plurality of views is located on the right side of the area 201. At this point, the area 201 may be located at an upper edge or a lower edge of the display area.

It would be appreciated that if a positional relationship of the three views in the view architecture is a vertical top-middle-bottom position, the corresponding three switch controls may be presented in the area 201 according to the positional relationship of the corresponding views and the vertical top-middle-bottom order. That is, a switch control for switching to an upper view is located on the upper side of the area 201, a switch control for switching to a middle view is located in the middle of the area 201, and a switch control for switching to a lower view is located on the lower side of the area 201). At this point, the area 201 may be located at a left edge or a right edge of the display area.

In some embodiments, the user may adjust the positional relationship between the plurality of views. The client device 110 may also update the view architecture in response to receiving an adjustment of the positional relationship between the plurality of views of the client device 110 by the user. Furthermore, the client device 110 may update the presentation positions of the plurality of switch controls based on the updated view architecture. For example, if the user switches the positions of the left view and the right view in the three views arranged horizontally, the client device 110 may switch the positions of the left switch control and the right switch control in the corresponding three switch controls in response to this adjustment of the user. For the example in FIG. 2, the sequence of the switch controls after the switch may be switch controls 206, 204, and 202.

In some embodiments, the plurality of views corresponding to the plurality of switch controls include at least a desktop view 210, the desktop view 210 including at least one desktop defined at the client device 110. Here, the desktop may represent a workspace where the user operates the client device 110, for example, in a certain desktop, the user may launch one or more applications. By default, the client device 110 may include only one default desktop (also referred to as a main desktop), and the user may add one or more other desktops according to his/her own needs.

In some embodiments, the plurality of views further include at least one of an application dock view 220 or a multitask view 230. The application dock view 220 includes a launch control for launching at least one application installed at the client device 110. The launch control may be, for example, an identification (such as an icon) of the application. The client device 110 may launch the application corresponding to the launch control in response to receiving a selection operation (such as a click operation, a double-click operation, a swipe operation, and the like) on the launch control.

The multitask view 230 includes a management control for managing an application that has been launched in the at least one desktop defined at the client device 110. The management control may include, for example, a user interface of the launched application(s). The client device 110 may switch to presenting a user interface of an application corresponding to the management control in response to receiving a selection operation on the management control.

In some embodiments, in the case where a plurality of desktops are included, the multitask view 230 further includes respective management controls of the plurality of desktops, and the management control here may be, for example, a thumbnail of the desktop. The client device 110 may present user interfaces of different applications in response to selection operations on thumbnails corresponding to different desktops. For example, if the user selects a thumbnail of a file application, a user interface of the file application is presented; and if the user selects a thumbnail of a chat application, a user interface of the chat application is presented, and so on.

The client device 110 presents a target view of the plurality of views that corresponds to a target switch control of the plurality of switch controls in the display area 115 in response to receiving a first user interaction for the target switch control. The first user interaction here may be, for example, a selection operation on the target switch control, and the selection operation may be, for example, a click operation, a double-click operation, a swipe operation, and the like. The client device 110 may present the target view in the display area 115 in response to receiving the selection operation on the target switch control.

Regarding the presentation position of the target view, in some embodiments, the client device 110 presents the target view in a second area other than the first area. As shown in FIG. 2, the client device 110 presents the plurality of switch controls in the area 201, and presents the target view in a portion of the display area 115 that is not obscured by the area 201.

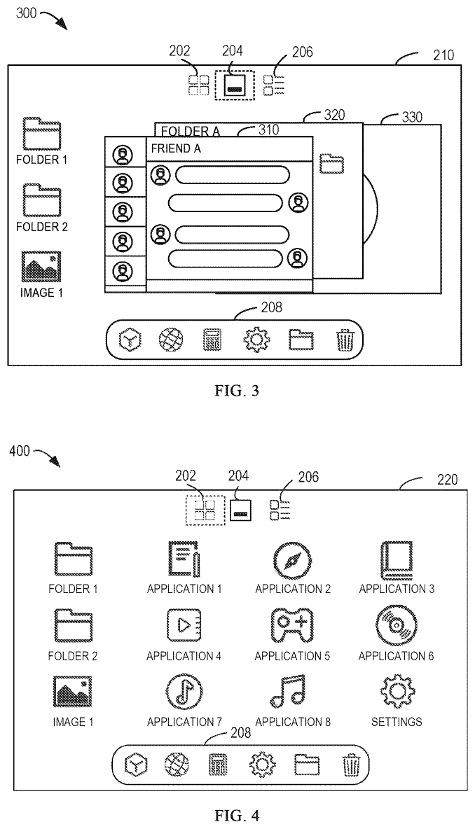

More details about the switching are described below in conjunction with FIG. 3 to FIG. 5. Specifically, FIG. 3 illustrates a block diagram 300 of a desktop view in accordance with some embodiments in the disclosure. As shown in FIG. 3, the client device 110 may present the desktop view 210 in the display area 115 in response to receiving a selection operation on the switch control 204. It should be noted that in this case, the desktop view 210 includes user interfaces of applications that have been launched in the desktop. For example, a user interface 310 of a chat application, a user interface 320 of a file application, . . . , and a user interface 330 of another application are shown in FIG. 3. At this point, the switch control of the currently presented view may be highlighted, for example, a dotted box may be presented around the switch control 204 to indicate that the desktop view is currently presented.

FIG. 4 illustrates a block diagram 400 of a launchpad view in accordance with some embodiments in the disclosure. As shown in FIG. 4, the client device 110 may present the application dock view 220 in the display area 115 in response to receiving a selection operation on the switch control 202. A dotted box may be presented around the switch control 202 to indicate that the launchpad view is currently presented.

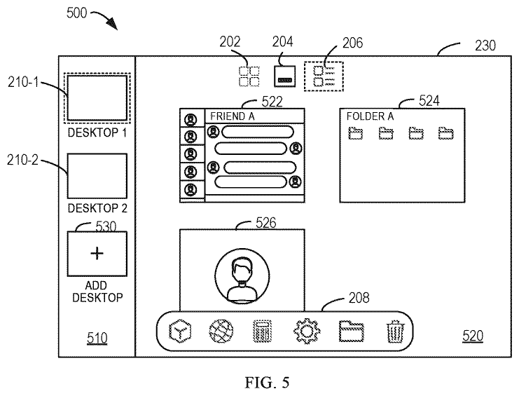

FIG. 5 illustrates a block diagram 500 of a multitask view in accordance with some embodiments in the disclosure. As shown in FIG. 5, the client device 110 may present the multitask view 230 in the display area 115 in response to receiving a selection operation on the switch control 206. The multitask view 230 may include an area 510 for displaying desktop identifications and an area 520 for displaying management controls of the applications. As shown in FIG. 5, each created desktop (for example, desktop 1 210-1, desktop 2 210-2) may be presented in the area 510 on the left side of the multitask view 230, and management controls (for example, management control 522 for managing the chat application, management control 524 for managing the file application, . . . , management control 526 for managing another application) of each launched application in each created desktop may be presented in the area 520 on the right side of the multitask view 230. A dotted box may be presented around the switch control 206 to indicate that the multitask view is currently presented.

In some embodiments, in addition to the above-mentioned manner of presenting the target view in response to the first user interaction, the client device 110 may further detect a second user interaction (for example, a swipe operation on the display area 115), and present the target view based on the second user interaction. Specifically, the client device 110 may determine a swipe direction of the second user interaction in response to detecting the second user interaction. The second user interaction here may be, for example, a swipe operation, a drag operation, or the like on the display area 115. The swipe direction of the second user interaction here includes either a horizontal direction or a vertical direction. The client device 110 may receive the second user interaction and determine the swipe direction of the second user interaction via, for example, a touch screen, a mouse, or other device.

The client device 110 may select a next target view corresponding to the second user interaction from the plurality of views based on the swipe direction, the target view, and the positional relationship. Specifically, the client device 110 may determine a direction opposite to the swipe direction, and select, from the plurality of views and based on the positional relationship, a view that is adjacent to the target view and along the opposite direction as the next target view. For example, if the positional relationship of the plurality of views is a horizontal arrangement, and if the swipe direction of the second user interaction is from left to right, the client device 110 may determine that the opposite direction is the left direction, and then select, from the plurality of views and based on the positional relationship in the view architecture, a view that is adjacent to the current target view and located on the left side of the current target view as the next target view.

Specifically, it is assumed that the positional relationship of the three views is (left: launchpad view; middle: desktop view; right: multitask view), and the target view currently presented is the desktop view. A rightward swipe operation may trigger the presentation of the launchpad view, and a leftward swipe operation may trigger the presentation of the multitask view. For another example, it is assumed that the target view currently presented is the launchpad view, then a rightward swipe operation no longer switches the view, and a leftward swipe operation may trigger the presentation of the desktop view. For another example, it is assumed that the target view currently presented is the multitask view, then a rightward swipe operation may trigger the presentation of the desktop view, and a leftward swipe operation no longer switches the view.

In some embodiments, the client device 110 may further determine the number of desktops included in the desktop view 210, and then present corresponding desktops in the desktop view 210. If only one desktop is defined, this desktop may be directly presented when switching to the desktop view 210. In some embodiments, the user is allowed to create a new desktop and/or delete an existing desktop. For example, the user may click on a button 530 in FIG. 5 to create a new desktop; alternatively and/or additionally, the user may select a desktop expected to be deleted, and delete the desktop in a menu popped up by a right click (or in other manners).

In response to determining that a plurality of desktops are defined at the client device 110, a current desktop may be determined based on default settings of the client device and/or user settings of a user of the client device, and the current desktop is presented in the display area 115. Specifically, a desktop with default settings (for example, a main desktop) may be presented in the desktop view 210. In the case where there are user settings, for example, the user activates another desktop different from the main desktop in historical operations, then another desktop may be presented at this point.

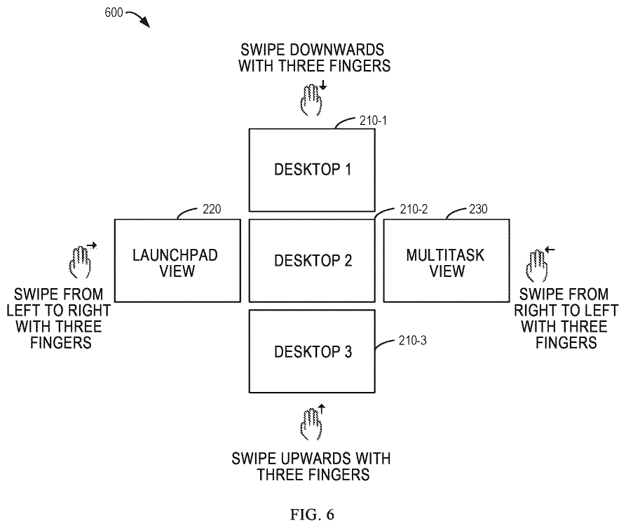

In some embodiments, the view architecture may further include a positional relationship between the plurality of desktops. For example, the plurality of desktops may be arranged in a vertical direction. More details about the view architecture are described with reference to FIG. 6, which illustrates a block diagram 600 of a cross architecture in accordance with some embodiments in the disclosure. As shown in FIG. 6, in the case where three desktops are included, the view architecture of the plurality of views may be the cross architecture. In such a view architecture, a certain desktop is taken as the center of the cross architecture, other desktops may be arranged above and below it, and the launchpad view and the multitask view may be arranged on the left and right sides of it.

In FIG. 6, the launchpad view 220, the desktop view 210 (including a plurality of desktops 210-1, 210-2, and 210-3), and the multitask view 230 may be arranged in a horizontal direction and in a left-center-right order. The plurality of desktops 210-1, 210-2, and 210-3 may be arranged in the vertical direction and in an upper-middle-lower order.

Furthermore, the client device 110 may determine a swipe direction of a third user interaction in response to detecting the third user interaction. Similarly, the third user interaction here may be, for example, a swipe operation, a drag operation, or the like on the display area 115. The swipe direction of the third user interaction here includes either the horizontal direction or the vertical direction. In the example of FIG. 6, the swipe direction of the third user interaction is the vertical direction. It should be noted that compared with the second user interaction that may be received when any view is displayed in the display area 115, the third user interaction may only be received by the client device 110 in the case where the desktop view is displayed in the display area 115. In other words, in the launchpad view 220 and the multitask view 230, the swipe operation in the vertical direction does not trigger the switching to other desktops.

The client device 110 may receive the third user interaction and determine the swipe direction of the third user interaction via, for example, a touch screen, mouse, or other devices. The client device 110 may then select a desktop adjacent to the current desktop from the plurality of desktops based on the swipe direction of the third user interaction, and present the adjacent desktop in the display area. For example, if the positional relationship of the plurality of desktops is a vertical arrangement, and if the swipe direction is from top to bottom, the client device 110 may determine that the opposite direction is the upper direction, and then select, from the plurality of desktops included in the desktop view and based on the positional relationship in the view architecture, an adjacent desktop that is located on the upper side of the current target desktop and adjacent to the current desktop, and present the adjacent desktop in the display area.

In the case where the target view is a view in the horizontal direction of the cross architecture, the second user interaction is in the horizontal direction, and the client device 110 may determine a next target view corresponding to the second user interaction from the launchpad view 220, desktop 2 210-2, and the multitask view 230 in response to detecting the second user interaction on the display area 115, and present the next target view in the display area 115. In the case where the target view is a desktop in the vertical direction of the cross architecture, the third user interaction is in the vertical direction, and the client device may determine an adjacent desktop corresponding to the third user interaction from desktop 1 210-1, desktop 2 210-2, and desktop 3 210-3 in response to detecting the third user interaction, and present the adjacent desktop in the display area 115.

It would be appreciated that the view architecture in FIG. 6 is only illustrative, and the view architecture may be defined in different manners. For example, the launchpad view, the desktop view, and the multitask view may be arranged in the vertical direction and in an upper-middle-lower order, and desktop 1, desktop 2, and desktop 3 may be arranged in the horizontal direction and in a left-center-right order. At this point, the plurality of switch controls may be presented on the left edge or the right edge of the display area, the swipe direction of the second user interaction may be the vertical direction, and the swipe direction of the third user interaction may be the horizontal direction. Specifically, different views may be switched by swiping in the vertical direction, and in the desktop view, different desktops may be switched by swiping in the horizontal direction.

In some embodiments, the view architecture of the plurality of views may also be, for example, a circular architecture, a grid architecture (for example, 3×3 or other formats), and the like. The embodiment in the disclosure takes the cross architecture as an example, but is not limited thereto. For example, under a 3×3 grid architecture, a view architecture including nine different views may be predefined. At this point, the user may swipe in a diagonal direction to switch to a predefined view.

With the example embodiment in the disclosure, the plurality of switch controls respectively corresponding to the plurality of views are presented in the display area 115 of the client device 110, and the target view corresponding to the target switch control is presented in the display area 115 in response to receiving the user interaction for the target switch control of the plurality of switch controls. In this way, in the case where the plurality of views are included, the view switching may be conveniently and quickly implemented through the switch controls, which facilitates improvement in the efficiency of view switching. Furthermore, the user interaction at this point is associated with the positional relationship in the view architecture, and performing the view switching based on the user interaction may strengthen the association between the user interaction and the view switching, and may improve the user experience of the user during the view switching.

### Example Process

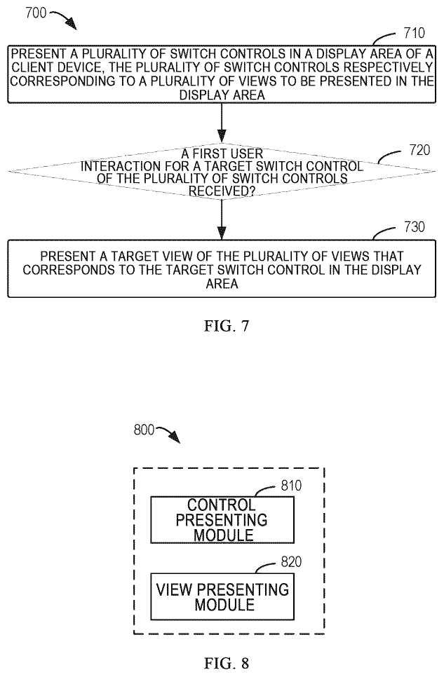

FIG. 7 illustrates a flowchart of a process 700 of view switching in accordance with some embodiments in the disclosure. The process 700 may be implemented at the client device 110. For purposes of discussion, the process 700 will be described with reference to the environment 100 of FIG. 1. At block 710, a plurality of switch controls are presented in a display area of a client device, the plurality of switch controls respectively corresponding to a plurality of views to be presented in the display area. At block 720, it may be determined whether a first user interaction for a target switch control of the plurality of switch controls is received. If the first user interaction is received, the process 700 proceeds to block 730. At block 730, a target view of the plurality of views that corresponds to the target switch control is presented in the display area.

In some embodiments, the plurality of views include: a desktop view including at least one desktop defined at the client device; and at least one of the following: a launchpad view including a launch control for launching at least one application installed at the client device; and a multitask view including a management control for managing an application in the at least one desktop defined at the client device.

In some embodiments, presenting the plurality of switch controls includes: obtaining a view architecture of the plurality of views, the view architecture representing a positional relationship between the plurality of views; and presenting the plurality of switch controls based on the positional relationship.

In some embodiments, the process 700 further includes: determining a swipe direction of a second user interaction in response to detecting the second user interaction; selecting a next target view corresponding to the second user interaction from the plurality of views based on the swipe direction, the target view, and the positional relationship; and presenting the next target view in the display area.

In some embodiments, selecting the next target view includes: determining a direction opposite to the swipe direction; and selecting, from the plurality of views and based on the positional relationship, a view that is adjacent to the target view and along the opposite direction as the next target view.

In some embodiments, presenting the target view in the display area further includes: determining, in response to determining that a plurality of desktops are defined at the client device, a current desktop based on at least one of the following: a default setting of the client device, a user setting of a user of the client device; and presenting the current desktop in the display area.

In some embodiments, the process 700 further includes: determining a swipe direction of a third user interaction in response to detecting the third user interaction; selecting a desktop adjacent to the current desktop from the plurality of desktops based on the swipe direction of the third user interaction; and presenting the adjacent desktop in the display area.

In some embodiments, the swipe direction of the second user interaction includes one of a horizontal direction or a vertical direction, and the swipe direction of the third user interaction includes the other one of the horizontal direction and the vertical direction.

In some embodiments, the process 700 further includes: updating the view architecture in response to receiving an adjustment to the positional relationship from the user of the client device.

In some embodiments, presenting the plurality of switch controls includes: presenting the plurality of switch controls in a first area of the display area; and presenting the target view includes: presenting the target view in a second area of the display area other than the first area.

In some embodiments, the first area is located at an edge of the display area, and the first area is always presented during operation of the client device.

In some embodiments, the first area is at least one of a task bar or a status bar in the display area.

### Example Apparatus and Device

FIG. 8 illustrates a block diagram of an apparatus 800 for view switching in accordance with some embodiments in the disclosure. The apparatus 800 may be implemented or included in, for example, the client device 110. Each module/component in the apparatus 800 may be implemented by hardware, software, firmware, or any combination thereof.

As shown in the figure, the apparatus 800 includes a control presenting module 810 configured to present a plurality of switch controls in a display area of a client device, the plurality of switch controls respectively corresponding to a plurality of views to be presented in the display area. The apparatus 800 further includes a view presenting module 820 configured to present a target view of the plurality of views that corresponds to a target switch control of the plurality of switch controls in the display area in response to receiving a first user interaction for the target switch control.

In some embodiments, the plurality of views include: a desktop view including at least one desktop defined at the client device; and at least one of the following: a launchpad view including a launch control for launching at least one application installed at the client device; and a multitask view including a management control for managing an application that has been launched in the at least one desktop defined at the client device.

In some embodiments, the control presenting module 810 includes: an architecture obtaining module configured to obtain a view architecture of the plurality of views, the view architecture representing a positional relationship between the plurality of views; and a switch control presenting module configured to present the plurality of switch controls based on the positional relationship.

In some embodiments, the apparatus 800 further includes: a first swipe direction determining module configured to determine a swipe direction of a second user interaction in response to detecting the second user interaction; a view selecting module configured to select a next target view corresponding to the second user interaction from the plurality of views based on the swipe direction, the target view, and the positional relationship; and a first view presenting module configured to present the next target view in the display area.

In some embodiments, the view selection module includes: an opposite direction determining module configured to determine a direction opposite to the swipe direction; and a second view presenting module configured to select, from the plurality of views and based on the positional relationship, a view that is adjacent to the target view and along the opposite direction as the next target view.

In some embodiments, the first view presenting module further includes: a desktop determining module configured to, determine, in response to determining that a plurality of desktops are defined at the client device, a current desktop based on at least one of the following: a default setting of the client device, a user setting of a user of the client device; and a desktop presenting module configured to present the current desktop in the display area.

In some embodiments, the apparatus 800 further includes: a second swipe direction determining module configured to determine a swipe direction of a third user interaction in response to detecting the third user interaction; an adjacent desktop selecting module configured to select a desktop adjacent to the current desktop from the plurality of desktops based on the swipe direction of the third user interaction; and an adjacent desktop presenting module configured to present the adjacent desktop in the display area.

In some embodiments, the swipe direction of the second user interaction includes one of a horizontal direction or a vertical direction, and the swipe direction of the third user interaction includes the other one of the horizontal direction and the vertical direction.

In some embodiments, the apparatus 800 further includes: an architecture updating module configured to update the view architecture in response to receiving an adjustment to the positional relationship from the user of the client device.

In some embodiments, the control presenting module 810 includes: a first presenting module configured to present the plurality of switch controls in a first area of the display area; and the view presenting module 820 includes a second presenting module configured to present the target view in a second area of the display area other than the first area.

In some embodiments, the first area is located at an edge of the display area, and the first area is always presented during operation of the client device.

In some embodiments, the first area is at least one of a task bar or a status bar in the display area.

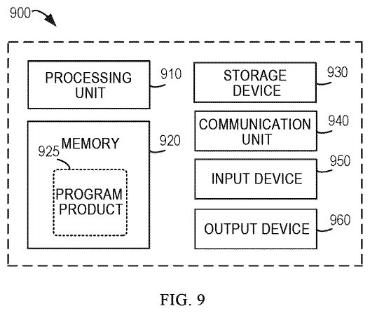

FIG. 9 illustrates a block diagram of an electronic device 900 in which one or more embodiments in the disclosure may be implemented. It would be appreciated that the electronic device 900 shown in FIG. 9 is only illustrative, and should not constitute any limitation on the function and scope of the embodiments described herein. The electronic device 900 shown in FIG. 9 may be used to implement the terminal device 110 in FIG. 1 and/or the apparatus 800 in FIG. 8.

As shown in FIG. 9, the electronic device 900 is in a form of a general-purpose electronic device. Components of the electronic device 900 may include, but are not limited to, one or more processors or processing units 910, a memory 920, a storage device 930, one or more communication units 940, one or more input devices 950, and one or more output devices 960. The processor 910 may be a physical or virtual processor and may perform various processes based on a program stored in the memory 920. In a multi-processor system, a plurality of processors perform computer executable instructions in parallel to improve the parallel processing capability of the electronic device 900.

The electronic device 900 typically includes a plurality of computer storage medium. Such medium may be any available medium that is accessible to the electronic device 900, including, but not limited to, volatile and non-volatile medium, removable and non-removable medium. The memory 920 may be a volatile memory (for example, a register, cache, a random access memory (RAM)), a non-volatile memory (such as a read-only memory (ROM), an electrically erasable programmable read-only memory (EEPROM), a flash memory), or any combination thereof. The storage device 930 may be any removable or non-removable medium, and may include a machine-readable medium such as a flash drive, a disk, or any other medium, which may be used to store information and/or data (such as training data for training) and may be accessed within the electronic device 900.

The electronic device 900 may further include additional removable/non-removable, volatile/non-volatile memory medium. Although not shown in FIG. 9, a disk drive for reading from or writing into removable and non-volatile disks (such as a “floppy disk”), and an optical disk drive for reading from or writing into removable and non-volatile optical disks may be provided. In these cases, each drive may be connected to a bus (not shown) via one or more data medium interfaces. The memory 920 may include a computer program product 925 having one or more program modules that are configured to perform various methods or acts of various embodiments in the disclosure.

The communication unit 940 enables communication with other electronic devices via the communication medium. Additionally, the functions of the components of the electronic device 900 may be implemented by a single computing cluster or a plurality of computing machines, which may communicate via communication connections. Therefore, the electronic device 900 may operate in a networked environment using a logical connection with one or more other servers, a network personal computer (PC), or another network node.

The input device 950 may be one or more input devices, such as a mouse, a keyboard, a tracking ball, and the like. The output device 960 may be one or more output devices, such as a display, a speaker, a printer, and the like. The electronic device 900 may also communicate with one or more external devices (not shown) such as a storage device and a display device, with one or more devices that enable the user to interact with the electronic device 900, or with any devices (such as a network card and a modem) that enable the electronic device 900 to communicate with one or more other electronic devices via the communication unit 940, as needed. Such communication may be performed via input/output (I/O) interfaces (not shown).

According to an example embodiment in the disclosure, there is provided a computer-readable storage medium having computer-executable instructions stored thereon, where the computer-executable instructions are executed by a processor to implement the method described above. According to an example embodiment in the disclosure, there is further provided a computer program product tangibly stored on a non-transitory computer-readable medium and including computer-executable instructions, which are executed by a processor to implement the method described above. According to an example embodiment in the disclosure, there is provided a computer program product having a computer program stored thereon, where the program, when executed by a processor, implements the method described above.

Various aspects in the disclosure are described herein with reference to the flowcharts and/or block diagrams of the method, apparatus, device, and computer program product implemented according to the disclosure. It would be appreciated that each block of the flowcharts and/or block diagrams, and a combination of various blocks in the flowcharts and/or block diagrams may be implemented by computer-readable program instructions.

These computer-readable program instructions may be provided to a processor of a general-purpose computer, a special-purpose computer, or other programmable data processing apparatus to produce a machine, such that when the instructions are executed by the processor of the computer or other programmable data processing apparatus, an apparatus for implementing a function/act specified in one or more blocks of the flowcharts and/or block diagrams is produced. These computer-readable program instructions may also be stored in a computer-readable storage medium, which instructions cause a computer, a programmable data processing apparatus, and/or other devices to operate in a particular way, so that the computer-readable medium storing the instructions includes an article of manufacture, which includes instructions for implementing various aspects of the function/act specified in one or more blocks of the flowcharts and/or block diagrams.

The computer-readable program instructions may be loaded onto a computer, another programmable data processing apparatus, or other devices, so that a series of operations and steps are performed on the computer, the other programmable data processing apparatus, or the other devices to generate a computer-implemented procedure, so that the instructions executed on the computer, the other programmable data processing apparatus, or the other devices implement the function/act specified in one or more blocks of the flowcharts and/or block diagrams.

The flowcharts and block diagrams in the drawings show the possibly implemented architectures, functions, and operations of the system, the method, and the computer program product according to a plurality of embodiments in the disclosure. In this regard, each block in the flowchart or block diagram may represent a module, program segment, or part of an instruction, which includes one or more executable instructions for implementing the specified logical function. In some alternative embodiments, the functions marked in the blocks may also occur in an order different from that marked in the drawings. For example, two consecutive blocks may actually be performed substantially in parallel, or they may sometimes be performed in the reverse order, depending on the functions involved. It should also be noted that each block in the block diagrams and/or flowcharts, and a combination of blocks in the block diagrams and/or flowcharts may be implemented by a special-purpose hardware-based system that perform a specified function or act, or may be implemented by a combination of special-purpose hardware and computer instructions.

The embodiments in the disclosure have been described above, and the above description is illustrative, non-exhaustive, and not limited to the disclosed embodiments. Many modifications and variations will be apparent to those of ordinary skill in the art without departing from the scope and spirit of the described embodiments. The terms used herein are chosen to best explain the principles of the embodiments, the practical applications, or improvements to the technologies in the market, or to enable other persons of ordinary skill in the art to understand the embodiments disclosed herein.

1. A method for view switching, comprising:
presenting a plurality of switch controls in a display area of a client device, the plurality of switch controls respectively corresponding to a plurality of views to be presented in the display area; and
presenting a target view of the plurality of views that corresponds to a target switch control of the plurality of switch controls in the display area in response to receiving a first user interaction for the target switch control.

2. The method of claim 1, wherein the plurality of views comprise:
a desktop view comprising at least one desktop defined at the client device; and at least one of:
a launchpad view comprising a launch control for launching at least one application installed at the client device; and
a multitask view comprising a management control for managing an application in the at least one desktop defined at the client device.

3. The method of claim 1, wherein presenting the plurality of switch controls comprises:
obtaining a view architecture of the plurality of views, the view architecture representing a positional relationship between the plurality of views; and
presenting the plurality of switch controls based on the positional relationship.

4. The method of claim 3, further comprising:
determining a swipe direction of a second user interaction in response to detecting the second user interaction;
selecting a next target view corresponding to the second user interaction from the plurality of views based on the swipe direction, the target view, and the positional relationship; and
presenting the next target view in the display area.

5. The method of claim 4, wherein selecting the next target view comprises:
determining a direction opposite to the swipe direction; and
selecting, from the plurality of views and based on the positional relationship, a view that is adjacent to the target view and along the opposite direction as the next target view.

6. The method of claim 4, wherein presenting the target view in the display area further comprises:
determining, in response to determining that a plurality of desktops are defined at the client device, a current desktop based on at least one of: a default setting of the client device, a user setting of a user of the client device; and
presenting the current desktop in the display area.

7. The method of claim 6, further comprising:
determining a swipe direction of a third user interaction in response to detecting the third user interaction;
selecting a desktop adjacent to the current desktop from the plurality of desktops based on the swipe direction of the third user interaction; and
presenting the adjacent desktop in the display area.

8. The method of claim 7, wherein the swipe direction of the second user interaction comprises one of a horizontal direction or a vertical direction, and the swipe direction of the third user interaction comprises the other one of the horizontal direction and the vertical direction.

9. The method of claim 3, further comprising: updating the view architecture in response to receiving an adjustment to the positional relationship from a user of the client device.

10. The method of claim 1, wherein:
presenting the plurality of switch controls comprises: presenting the plurality of switch controls in a first area of the display area; and
presenting the target view comprises: presenting the target view in a second area of the display area other than the first area.

11. The method of claim 10, wherein the first area is located at an edge of the display area, and the first area is always presented during operation of the client device.

12. The method of claim 10, wherein the first area is at least one of a task bar or a status bar in the display area.

13. (canceled)

14. An electronic device, comprising:
at least one unit processor; and
at least one memory, the at least one memory coupled to the at least one processor and storing instructions executable by the at least one processor, the instructions, when executed by the at least one processor, causing the electronic device to perform operations comprising:
presenting a plurality of switch controls in a display area of a client device, the plurality of switch controls respectively corresponding to a plurality of views to be presented in the display area; and
presenting a target view of the plurality of views that corresponds to a target switch control of the plurality of switch controls in the display area in response to receiving a first user interaction for the target switch control.

15. A non-transitory computer-readable storage medium having a computer program stored thereon, the computer program, when executed by a processor, causing the processor to implement the method of claim 1.

16. The electronic device of claim 14, wherein the plurality of views comprise:
a desktop view comprising at least one desktop defined at the client device; and at least one of:
a launchpad view comprising a launch control for launching at least one application installed at the client device; and
a multitask view comprising a management control for managing an application in the at least one desktop defined at the client device.

17. The electronic device of claim 14, wherein presenting the plurality of switch controls comprises:
obtaining a view architecture of the plurality of views, the view architecture representing a positional relationship between the plurality of views; and
presenting the plurality of switch controls based on the positional relationship.

18. The electronic device of claim 17, wherein the operations further comprising:
determining a swipe direction of a second user interaction in response to detecting the second user interaction;
selecting a next target view corresponding to the second user interaction from the plurality of views based on the swipe direction, the target view, and the positional relationship; and
presenting the next target view in the display area.

19. The electronic device of claim 18, wherein selecting the next target view comprises:
determining a direction opposite to the swipe direction; and
selecting, from the plurality of views and based on the positional relationship, a view that is adjacent to the target view and along the opposite direction as the next target view.

20. The electronic device of claim 18, wherein presenting the target view in the display area further comprises:
determining, in response to determining that a plurality of desktops are defined at the client device, a current desktop based on at least one of: a default setting of the client device, a user setting of a user of the client device; and
presenting the current desktop in the display area.

21. The electronic device of claim 20, wherein the operations further comprising:
determining a swipe direction of a third user interaction in response to detecting the third user interaction;
selecting a desktop adjacent to the current desktop from the plurality of desktops based on the swipe direction of the third user interaction; and
presenting the adjacent desktop in the display area.
